(19) United States
(12) Patent Application Publication
(10) Pub. No.: US 2009/0017349 A1
(43) Pub. Date: Jan. 15, 2009

(54) FUEL CELL SYSTEM AND TRANSPORTATION APPARATUS INCLUDING THE SAME

(75) Inventor: Hideo Kohda, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KAUSHIKI KAISHA, Iwata-shi (JP)

(21) Appl. No.: 10/562,772

(22) PCT Filed: May 2, 2005
(86) PCT No.: PCT/JP2005/008661

§ 371 Date: Oct. 3, 2008

(30) Foreign Application Priority Data
May 13, 2004 (JP) 2004-143410

(51) Int. Cl. H01M 8/04

(52) U.S. Cl. 429/22; 429/34

(57) ABSTRACT

A fuel cell system includes a fuel cell which generates electric energy by an electro-chemical reaction, a water tank which stores water from the fuel cell, an intake pipe which has an inlet port for introducing moisture-containing exhaust gas from the fuel cell into the water tank and is connected with the water tank, an exhaust pipe which has an exhaust port for exhausting gas from the water tank and is connected with the water tank, and a partition member which is provided in the water tank at a position lower than the inlet port for partitioning an interior of the water tank into an upper space and the lower space. The fuel cell system is capable of collecting water from the fuel cell easily and efficiently without depending upon a large component or decreasing power generation efficiency.

### BACKGROUND OF THE INVENTION

1. Field of the Invention

The present invention relates to a fuel cell system and a transportation apparatus including the same, and more specifically to a fuel cell system in which water from the fuel cell is stored in a water tank, and a transportation apparatus such as a two-wheeled vehicle including such a fuel cell system.

2. Description of the Related Art

Conventionally, in the field of fuel cell systems, proposals have been made for techniques to collect water that has been discharged from the fuel cell.

For example, Japanese Unexamined Patent Application Publication No. 2002-124290 discloses a water collector. In the method described in Japanese Unexamined Patent Application Publication No. 2002-124290, moisture-containing fuel gas from the fuel cell is introduced to a tubular path where a number of partitioning plates are disposed. According to the water collector disclosed in Japanese Unexamined Patent Application Publication No. 2002-124290, moisture-containing fuel gas moves through the tubular path while contacting the partitioning plates whereby water is separated from the fuel gas. Thereafter, the water is collected in a water tank while the fuel gas is exhausted from an exhaust port.

However, the technique according to Japanese Unexamined Patent Application Publication No. 2002-124290 requires a water collector which includes a tubular path in which a plurality of partitioning plates are disposed. This poses a problem of increasing the size of the water collector.

Further, in order to move the moisture-containing fuel gas while contacting many partitioning plates, a greater output is required for an air pump which introduces the fuel gas into the tubular path. As a result, power consumption by the air pump increases, which decreases power generation efficiency of the fuel cell system.

On the other hand, in direct methanol fuel cell systems in particular, it is necessary that a large amount of water which flows into the water tank is efficiently collected and supplied to an aqueous solution tank. If the water tank is small and exhaust gas from the fuel cell is introduced into the water tank, there is a problem that the gust of exhaust gas blows the water out of the tank, thereby decreasing water collection efficiency.

### SUMMARY OF THE INVENTION

In order to overcome the problems described above, preferred embodiments of the present invention provide a fuel cell system that is capable of collecting water from the fuel cell easily and efficiently without requiring a large component and without decreasing power generation efficiency, and to provide a transportation apparatus including such a fuel cell system.

According to a preferred embodiment of the present invention there is provided a fuel cell system which includes a fuel cell which generates electric energy, a water tank which stores water from the fuel cell, an inlet port for introducing moisture-containing exhaust gas from the fuel cell into the water tank, an exhaust port for exhausting gas from the water tank, and a partition member which is provided in the water tank at a position lower than the inlet port for partitioning an interior of the water tank into an upper space and a lower space.

In this preferred embodiment of the present invention, by providing a partition member which divides the interior of water tank, an upper space in which moisture-containing exhaust gas is introduced from the intake pipe, and a lower space in which water is stored, are provided. Most of the exhaust gas flowing into the water tank at a high velocity contacts the partition member and swirls in the upper space, and the lesser remaining portion of the exhaust gas contacts the water stored in the lower space. As a result, it becomes possible to prevent the water in the water tank from being blown upwardly by the whirling gust of exhaust gas and being discharged from the exhaust port. Therefore, water can be collected easily and efficiently without increasing the volume of the water tank to decrease the velocity of gust of exhaust gas. In other words, water can be collected easily and efficiently using only a small water tank. Further, since there is no need for a large water collector, nor electric power to drive the collector, there is no decrease in power generation efficiency. In addition, if the amount of water in the water tank exceeds the volume of the lower space, water which overflows into the upper space is blown upwardly by the swirling gust of exhaust gas circulating in the upper space and is discharged from the exhaust port. This provides virtual water level adjustment, and therefore there is no need for a device which prevents water in the water tank from overflowing, nor electricity to drive the device, and there is no decrease in power generation efficiency in this respect also.

Preferably, the partition member has a plurality of through-holes. In this case, water which is introduced into the upper space can easily flow down to the lower space through these through-holes, allowing for highly efficient water collection. Exhaust gas introduced from the fuel cell into the upper space is hot and contains water vapor. The through-holes provided in the partition member increase the exhaust gas cooling space by the volumes of the holes, facilitating condensation of the water vapor contained in the exhaust gas, thereby enabling more water to be collected.

Further preferably, the partition member is spaced by a gap from an inner wall of the water tank. In this case, it becomes possible for the water which is introduced in the upper space to readily fall through the gap into the lower space, enabling efficient collection of the water.

Further preferably, the fuel cell system further includes a projection which is arranged in the water tank so as to be spaced a predetermined distance from the partition member, blocking the gap between the inner wall of the water tank and the partition member in a vertical view. In this case, even if the gust of exhaust gas comes into the lower space and blows the stored water, the projection prevents the water from being blown upwardly. Therefore, water in the lower space is not blown upwardly into the upper space, thereby facilitating efficient collection of water.

Preferably, the inlet port and the exhaust port do not face each other in the water tank. By offsetting the inlet port from the exhaust port so that they will not face each other in the water tank, it becomes possible to prevent water which is introduced from the inlet port, from immediately being blown into the exhaust port and being discharged therefrom, making it possible to collect water efficiently.

Further, the fuel cell system also preferably includes a water level sensor for detecting a level of water in the water tank, which is preferably disposed at a position lower than the partition member in the water tank. In this case, the water level sensor detects the level of water in the water tank in the lower space which is not really subject to the effects of the swirling gusts of exhaust gas and therefore is able to reliably store water in a stable manner. Thus, it is possible to detect the level of water in the water tank accurately.

Further, the partition member preferably has an upper surface that is slanted with respect to a surface of the water in the water tank. In this case, water which is introduced in the upper space flows on the upper surface of the partition member down into the lower space more easily, making water collection even more efficient.

According to another preferred embodiment of the present invention, there is provided a fuel cell system which includes a fuel cell which generates electric energy by an electro-chemical reaction, a water tank which stores water from the fuel cell, and an intake pipe which has a trumpet-shaped inlet port for introducing moisture-containing exhaust gas from the fuel cell into the water tank and is connected with the water tank.

According to this preferred embodiment of the present invention, the moisture-containing exhaust gas from the fuel cell is introduced into the water tank via the intake pipe which has a trumpet-shaped inlet port. This reduces the velocity of the moisture-containing exhaust gas as it enters the water tank, and thus reduces the speed of swirling gusts of exhaust gas that occur in the water tank. Therefore, water in the water tank is not blown upwardly easily, thereby enabling easy and efficient collection of water.

In direct methanol fuel cell systems, the fuel cell is supplied directly with methanol aqueous solution, so direct methanol fuel cell systems do not require a reformer, and can have a simplified system configuration. For this reason, direct methanol fuel cell systems are used suitably in an apparatus in which portability is essential and/or smallness in size is desired. For the sake of size reduction of the direct methanol fuel cell systems and thus the apparatus which utilizes the direct methanol fuel cell systems, water discharged from the fuel cell must be collected efficiently into a small water tank. The present invention enables efficient water collection even for a small water tank, and therefore is particularly advantageous in direct methanol fuel cell systems which are utilized suitably in an apparatus in which portability is essential and/or smallness in size is desired.

Since the present invention enables a significant reduction in the size of the water tank, and thus the size of the entire fuel cell system, the fuel cell system can be suitably utilized in a transportation apparatus.

The above described objects and other objects, features, elements, aspects and advantages of the present invention will become more apparent from the following detailed description of preferred embodiments of the present invention when taken in conjunction with the accompanying drawings.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a schematic diagram showing a primary portion of a fuel cell system according to a preferred embodiment of the present invention.

FIG. 2 is a perspective view which shows the fuel cell system mounted on a frame of a motorcycle.

FIG. 3 is an illustrative drawing which shows a primary portion of the fuel cell system.

FIG. 4 is a block diagram which shows an electrical construction of the fuel cell system.

FIG. 5 is a side view which shows a water tank and its surrounding elements.

FIG. 6 is an illustrative sectional view which shows the water tank and its surrounding elements.

FIG. 7 is a plan view which shows the water tank and its surrounding elements.

FIG. 8 is a rear view which shows a water tank and its surrounding elements.

FIG. 9 is a sectional view taken along line A-A in FIG. 5.

FIG. 10 is a side view which shows a water tank with a partition member slanted therein, and the surrounding elements of the tank.

### DETAILED DESCRIPTION OF PREFERRED EMBODIMENTS

Hereinafter, preferred embodiments of the present invention will be described with reference to the drawings.

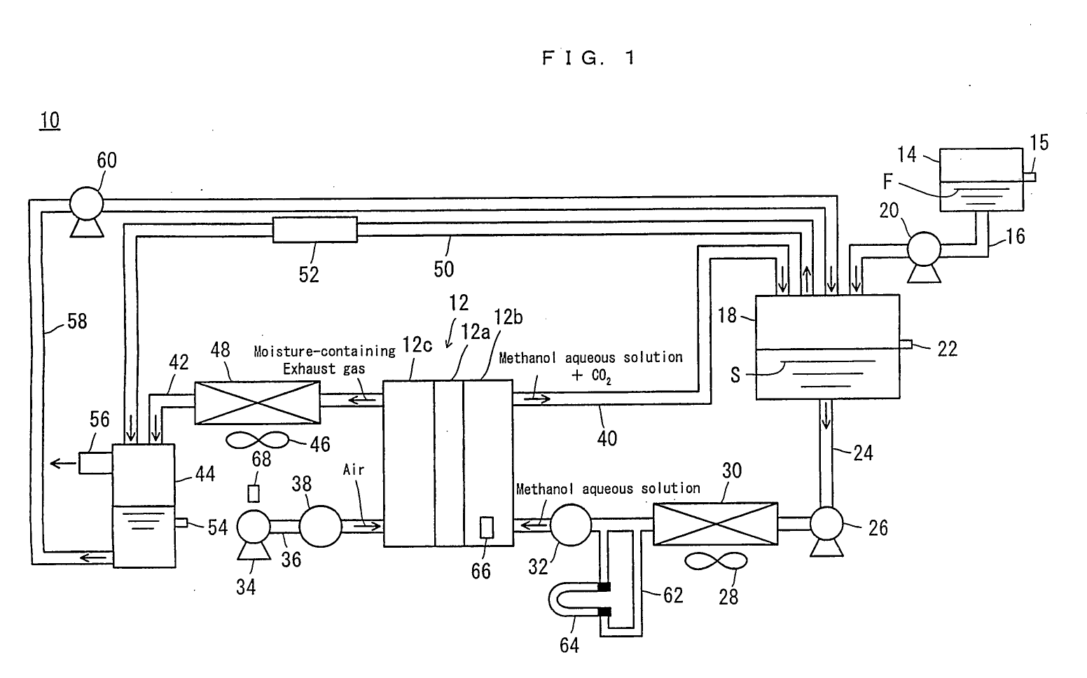

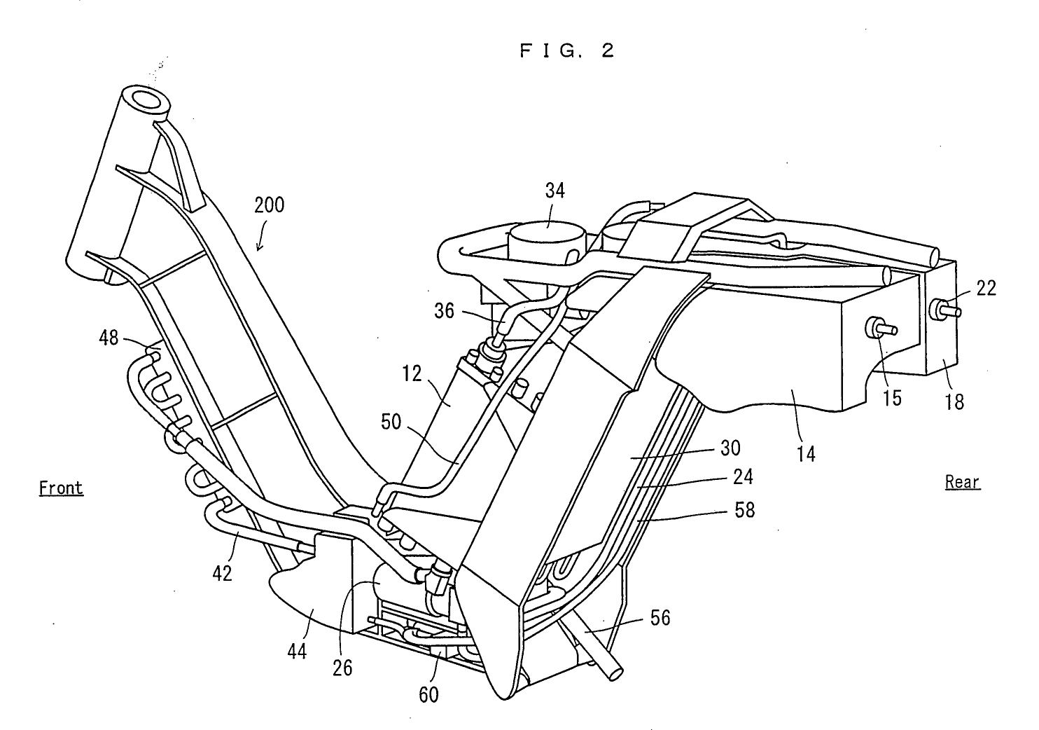

As shown in FIG. 1 through FIG. 4, a fuel cell system 10 according to a preferred embodiment of the present invention is provided as a direct methanol fuel cell system. Direct methanol fuel cell systems do not require a reformer, and therefore are used suitably in an apparatus in which portability is essential and/or smallness in size is desired. Here, description will be made for a case in which the fuel cell system 10 is used in a motorcycle as an example of a transportation apparatus. Note that in FIG. 2, the motorcycle will be represented only by a vehicle frame 200. The fuel cell system 10 is disposed along the vehicle frame 200.

Referring mainly to FIG. 1, the fuel cell system 10 includes a fuel cell 12. The fuel cell 12 is constructed as a fuel cell stack including a plurality of direct methanol fuel cells connected (laminated) in series, each of which includes an electrolyte 12a, and a pair of an anode (fuel electrode) 12b and a cathode (air electrode) 12c which sandwich the electrolyte 12a.

The fuel cell system 10 includes a fuel tank 14 which holds highly concentrated methanol fuel (aqueous solution containing approximately 50 wt % of methanol, for example) F. The fuel tank 14 is connected, via a fuel supply pipe 16, with an aqueous solution tank 18 which stores methanol aqueous solution S. The fuel supply pipe 16 is provided with a fuel pump 20. The fuel pump 20 supplies the aqueous solution tank 18 with the methanol fuel F from the fuel tank 14.

The fuel tank 14 is provided with a water level sensor 15 for detecting the level of methanol fuel F in the fuel tank 14. The aqueous solution tank 18 is provided with a water level sensor 22 for detecting the level of methanol aqueous solution S in the aqueous solution tank 18. The aqueous solution tank 18 is connected, via an aqueous solution pipe 24, with the anode 12b of the fuel cell 12. The aqueous solution pipe 24 is provided with an aqueous solution pump 26, a heat exchanger 30 equipped with a cooling fan 28, and an aqueous solution filter 32, respectively from the upstream side. The methanol aqueous solution S in the aqueous solution tank 18 is pumped by the aqueous solution pump 26 toward the anode 12b, cooled by the heat exchanger 30 as necessary, and then purified by the aqueous solution filter 32 before being supplied to the anode 12b.

On the other hand, the cathode 12c in the fuel cell 12 is connected with an air pump 34 via an air pipe 36. The air pipe 36 is provided with an air filter 38. Thus, air which contains oxygen is sent from the air pump 34, purified by the air filter 38 and then supplied to the cathode 12c.

The anode 12b and the aqueous solution tank 18 are connected with each other via a pipe 40, so unused methanol aqueous solution S and produced carbon dioxide that is discharged from the anode 12b are supplied to the aqueous solution tank 18.

Further, the cathode 12c is connected with the water tank 44 via a pipe 42. The pipe 42 is provided with a gas-liquid separator 48 equipped with a cooling fan 46. Exhaust gas which is discharged from the cathode 12c and contains moisture (water and water vapor) is supplied to the water tank 44 via the pipe 42.

The aqueous solution tank 18 and the water tank 44 are connected with each other via the CO₂ vent pipe 50. The CO₂ vent pipe 50 is provided with a methanol trap 52 which separates the methanol aqueous solution S. The carbon dioxide that is discharged from the aqueous solution tank 18 is thus supplied to the water tank 44.

The water tank 44 is provided with a water level sensor 54, which detects the level of water in the water tank 44. The water tank 44 is provided with an exhaust gas pipe 56. The exhaust gas pipe 56 emits carbon dioxide and the exhaust gas from the cathode 12c.

The water tank 44 is connected with the aqueous solution tank 18 via a water return pipe 58. The water return pipe 58 is provided with a water pump 60. Water in the water tank 44 is returned to the aqueous solution tank 18 by the water pump 60 as necessary depending on the status of the aqueous solution tank 18.

In the aqueous solution pipe 24, a bypass pipe 62 is provided between the heat exchanger 30 and the aqueous solution filter 32.

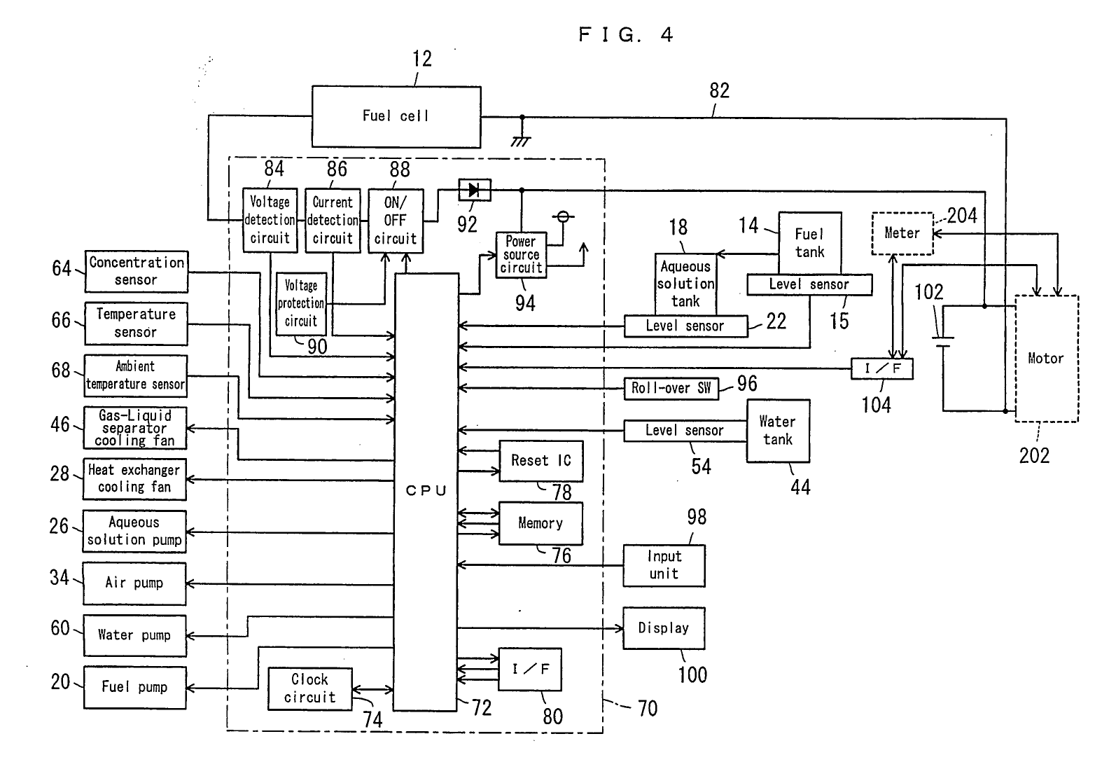

Referring also to FIG. 4, in the fuel cell system 10, the bypass pipe 62 is provided with a concentration sensor 64 for detecting the concentration of methanol aqueous solution S. A temperature sensor 66 for detecting the temperature of the fuel cell 12 is attached to the fuel cell 12 whereas an ambient temperature sensor 68 for detecting the ambient temperature is provided near the air pump 34.

As shown in FIG. 4, the fuel cell system 10 includes a control circuit 70.

The control circuit 70 includes a CPU 72 which performs necessary calculations and controls operations of the fuel cell system 10, a clock circuit 74 which supplies a clock to the CPU 72, a memory 76 provided by e.g., an EEPROM which stores programs and data necessary for controlling the fuel cell system 10 as well as calculation data, etc, a reset IC 78 which prevents malfunction of the fuel cell system 10, an interface circuit 80 for connections with external devices, a voltage detection circuit 84 which detects voltages in an electric circuit 82 to which the fuel cell 12 is connected to a motor 202 to drive the motorcycle, an electric current detection circuit 86 which detects electric current flowing in the electric circuit 82, an ON/OFF circuit 88 which opens and closes the electric circuit 82, a voltage protection circuit 90 which prevents an over voltage condition in the electric circuit 82, a diode 92 provided in the electric circuit 82, and a power source circuit 94 which supplies a predetermined voltage to the electric circuit 82.

In the control circuit 70 as described above, the CPU 72 is supplied with detection signals from the concentration sensor 64, the temperature sensor 66 and the ambient temperature sensor 68. Further, the CPU 72 is supplied with detection signals from a roll-over switch 96 which detects whether or not the vehicle has rolled over. Further, the CPU 72 is supplied with other signals from an input unit 98 for making various settings and information entry. Still further, the CPU 72 is supplied with detection signals from the water level sensors 15, 22 and 54 as well.

The CPU 72 controls various components such as the fuel pump 20, the aqueous solution pump 26, the air pump 34, the heat-exchanger cooling fan 28, the gas-liquid separator cooling fan 46 and the water pump 60. The CPU 72 also controls a display 100 which displays various information to notify the motorcycle rider.

The fuel cell 12 has a parallel connection with a secondary battery 102. The secondary battery 102 also has a parallel connection with the motor 202. The secondary battery 102 supplements the output from the fuel cell 12, is charged with electric energy from the fuel cell 12, and discharges to provide the motor 202 and other components with electric energy.

The motor 202 is provided with a meter 204 which makes measurements for various data concerning the motor 202. These data and status information about the motor 202 measured by the meter 204 are supplied to the CPU 72 via the interface circuit 104.

Next, the water tank 44 will be described in detail.

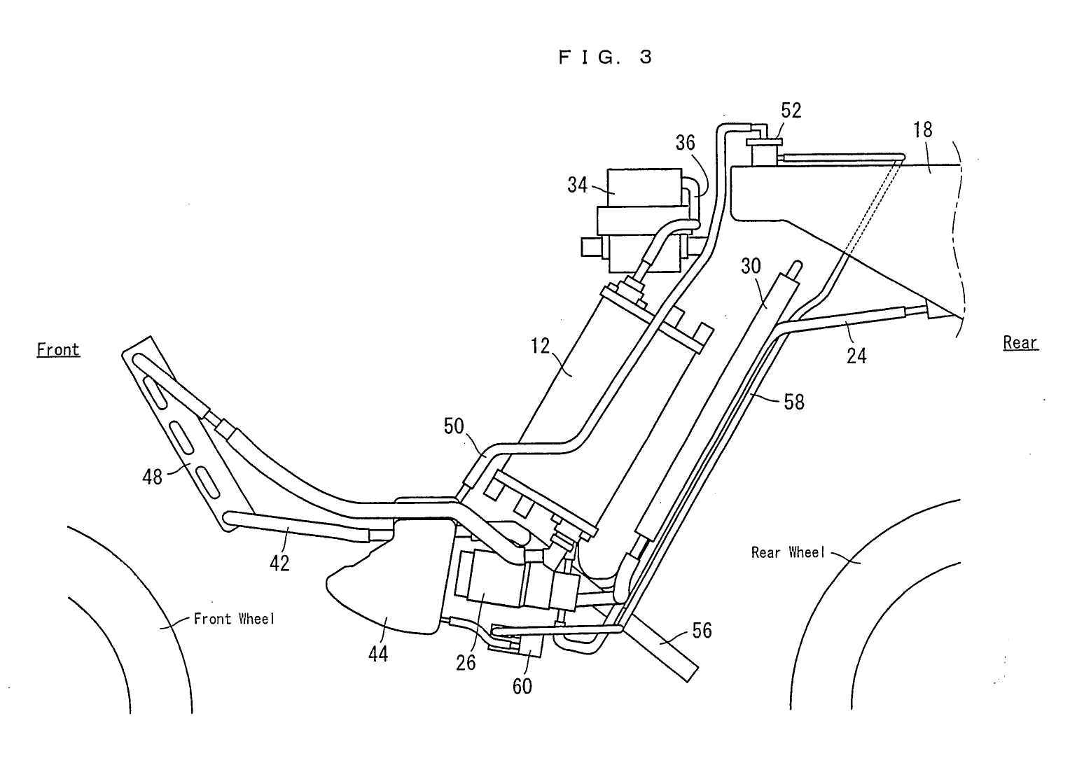

As shown in FIG. 2 and FIG. 3, the water tank 44 is made of FRP for example, is small so as to fit within a predetermined region in the vehicle frame 200, and has a lower portion that bulges more than the upper portion.

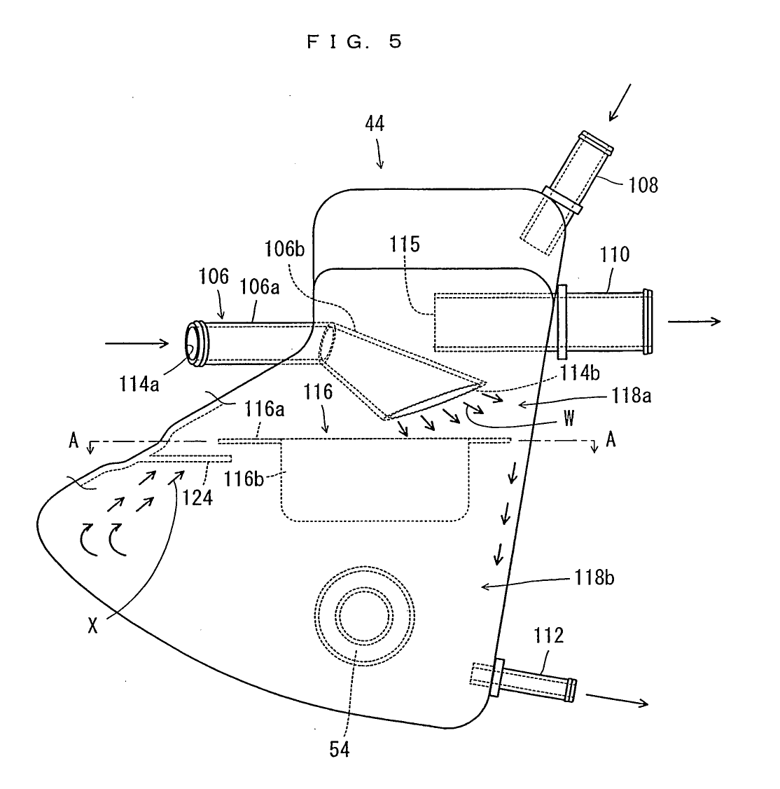

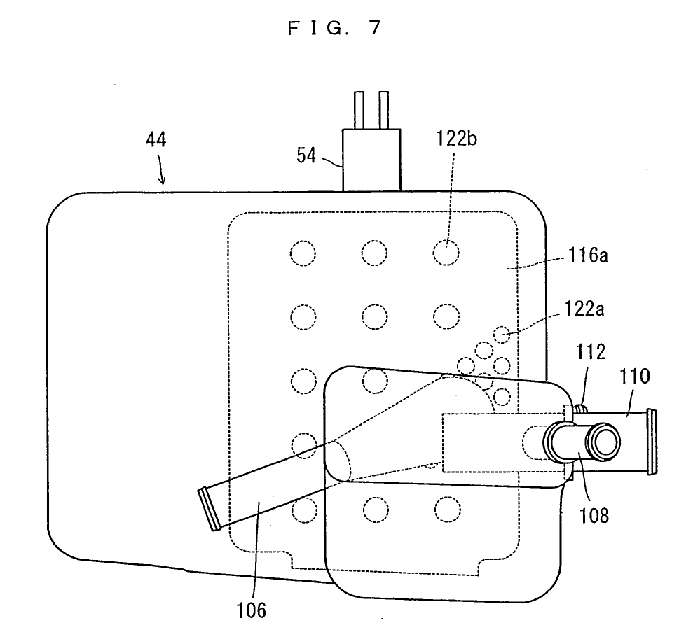

Referring to FIG. 5 through FIG. 9, intake pipes 106, 108, an exhaust pipe 110 and a discharge pipe 112, each made of SUS 304, for example, are inserted into the water tank 44.

The intake pipe 106 has a cylindrical portion 106a which goes into the water tank 44 from the front and slightly upper position of the water tank 44, and a generally trumpet-shaped (funnel-shaped) opening portion 106b which faces downward in the water tank 44. The opening portion 106b has an inlet port 114b whose opening is greater than an entrance 114a of the cylindrical portion 106a. The cylindrical portion 106a is connected with the pipe 42.

The exhaust pipe 110 is a cylindrical pipe which goes into the water tank 44 from the back of the water tank 44, and is disposed so that its exhaust port 115 is above an opening portion 106b of the intake pipe 106 in the water tank 44. As described, the opening portion 106b and the exhaust pipe 110 are arranged so that the inlet port 114b and the exhaust port 115 do not face each other in the water tank 44. The exhaust pipe 110 is connected with the exhaust gas pipe 56.

The intake pipe 108 is preferably a cylindrical pipe which goes into the water tank 44 from the upper surface corner of the water tank 44, and is disposed above the exhaust pipe 110 in the water tank 44. The intake pipe 108 is connected with the CO₂ vent pipe 50.

The discharge pipe 112 is preferably a cylindrical pipe which goes into the water tank 44 from the back and near the bottom of the water tank 44. The discharge pipe 112 is connected with the water return pipe 58.

Therefore, moisture-containing exhaust gas which comes from the cathode 12c flows through the pipe 42 and the intake pipe 106, into the water tank 44. Carbon dioxide which comes through the aqueous solution tank 18 and the CO₂ vent pipe 50 flows into the intake pipe 108 and then to the water tank 44. Water in the water tank 44 goes into the discharge pipe 112 and then flows into the water return pipe 58. Exhaust gas which contains carbon dioxide in the water tank 44 flows through the exhaust pipe 110 and the exhaust gas pipe 56 and then is released to the outside.

Further, a partition member (wind shield member) 116 is provided inside the water tank 44. The partition member 116 is preferably made of SUS304 for example, and includes a generally rectangular and plate-like separator 116a and a mounting tab 116b which is bent generally squarely with respect to the separator 116a. The partition member 116 is fixed inside the water tank 44 by attaching the mounting tab 116b to an inner wall of the water tank 44 so that the separator 116a becomes generally horizontal. The separator 116a partitions the interior of water tank 44 into an upper space 118a and a lower space 118b. In the upper space 118a, there are the intake pipes 106, 108 and the exhaust pipe 110. In the lower space 118b, there is the discharge pipe 112.

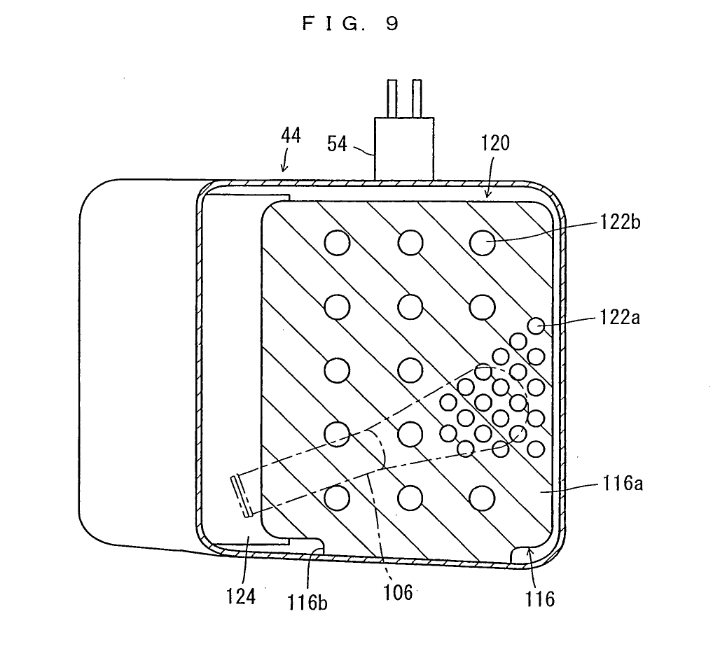

The partition member 116 is attached at a height that is high enough for the lower space 118b to hold a sufficient amount of water necessary to supply to the aqueous solution tank 18. Further, as shown in FIG. 9, the partition member 116 is positioned so that no parts of the partition member other than the mounting tab 116b make contact with the inside walls of the water tank 44, i.e., so that all three outer sides of the separator 116a are spaced from the corresponding three inside walls of the water tank 44, by a gap 120.

The separator 116a is preferably provided with a plurality (for example, twenty one in this preferred embodiment) of small-diameter through-holes 122a and a plurality (for example, thirteen in this preferred embodiment) of large-diameter through-holes 122b. The small-diameter through-holes 122a face the inlet port 114b, and are concentrated in an area that is blasted by moisture-containing exhaust gas from the inlet port 114b. Preferably, the small-diameter through-holes 122a have a diameter of about 4 mm, and the large-diameter through-holes 122b have a diameter of about 6 mm, for example. By providing the small-diameter through-holes 122a in such a location, it becomes possible to collect water efficiently while reducing entry of the exhaust gas into the lower space 118b.

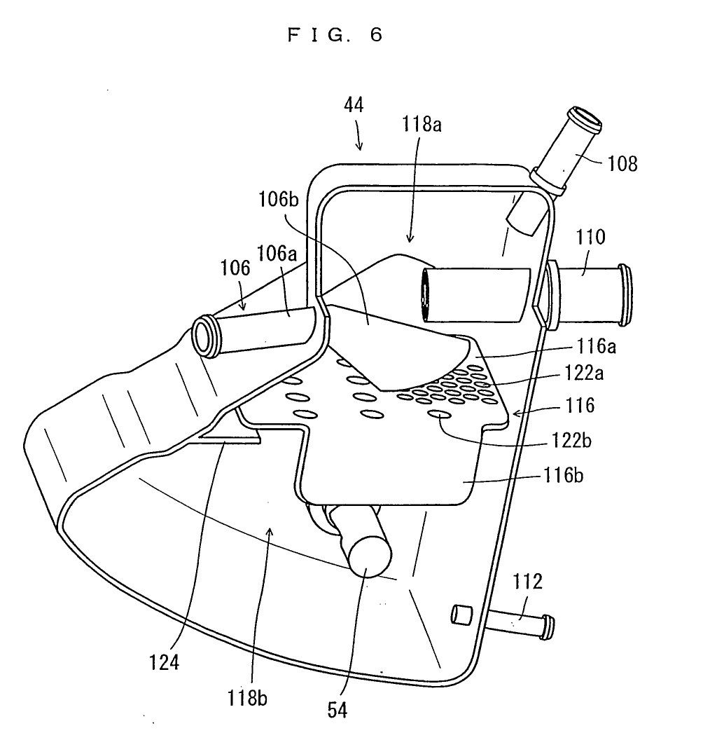

Further, as shown in FIG. 6, a projection (obstruction plate) 124 is provided on a front inner wall in the lower space 118b, below the separator 116a and at a predetermined gap from the separator 116a. When viewed vertically, the projection 124 appears to block the gap 120 between the front inner wall of the water tank 44 and the separator 116a.

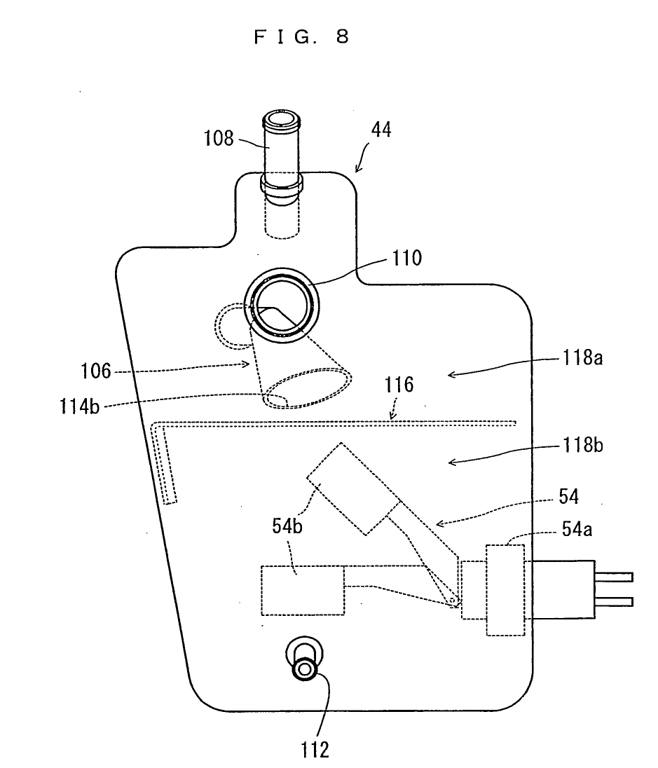

In the lower space 118b, there is disposed a water level sensor 54 provided by a float sensor for detecting the water level in the water tank 44. As shown in FIG. 8, the water level sensor 54 includes a sensor main body 54a and a float portion 54b attached to the sensor main body 54a. The water level sensor 54 is able to detect the water level in the lower space 118b as the float portion 54b floats up and down when the water level changes in the lower space 118b.

An example of the operation of the fuel cell system 10 during power generation will be described.

When power generation is started, a highly concentrated methanol aqueous solution S which is stored in the aqueous solution tank 18 is pumped by the aqueous solution pump 26 toward the fuel cell 12. The solution is cooled as necessary by the heat exchanger 30, purified by the aqueous solution filter 32, and then supplied to the anode 12b. On the other hand, air which contains oxygen is pumped by the air pump 34 toward the fuel cell 12. The air is purified by the air filter 38 and then supplied to the cathode 12c.

On the anode 12b in the fuel cell 12, methanol and water in the methanol aqueous solution S react electro-chemically with each other to produce carbon dioxide and hydrogen ions. The hydrogen ions move through the electrolyte 12a to the cathode 12c, where the hydrogen ions react electro-chemically with oxygen in the air which is supplied to the cathode 12c, to produce water and electric energy.

Carbon dioxide which occurs on the anode 12b in the fuel cell 12 flows through the pipe 40, the aqueous solution tank 18, the CO₂ vent pipe 50 and the intake pipe 108, then supplied to the water tank 44, and then it is exhausted from the exhaust gas pipe 56 via the exhaust pipe 110.

On the other hand, most of the water vapor occurring on the cathode 12c in the fuel cell 12 is liquefied and discharged in the form of water, with saturated water vapor being discharged in the form of gas. Part of the water vapor which was discharged from the cathode 12c is liquefied by lowering the dew point in the gas-liquid separator 48. Moisture (water and water vapor) and unused air from the cathode 12c are supplied to the water tank 44 via the pipe 42 and the intake pipe 106. Also, water which has moved to the cathode 12c due to the water crossover is discharged from the cathode 12c and supplied to the water tank 44. Further, water and carbon dioxide which occurred at the cathode 12c due to the methanol crossover are discharged from the cathode 12c and supplied to the water tank 44.

It should be noted here that the term water crossover is a phenomenon in which a few mols of water moves to the cathode 12c, accompanying the hydrogen ions which occur at the anode 12b and are moving to the cathode 12c. The term methanol crossover is a phenomenon in which methanol moves to the cathode 12c, accompanying the hydrogen ions which move to the cathode 12c. At the cathode 12c, the methanol reacts with air supplied from the air pump 34, and thereby decomposes into water and carbon dioxide.

The exhaust gas which contains moisture (water and water vapor) from the cathode 12c are pumped by the air pump 34 into the upper space 118a via the inlet port 114b of the intake pipe 106 as indicated by arrow W in FIG. 5. This causes a strong gust of exhaust gas in the water tank 44. Most of the exhaust gas hits the separator 116a of the partition member 116 and swirls in the upper space 118a, and thus does not flow very much into the lower space 118b. Water which has been introduced from the inlet port 114b into the upper space 118a flows down through the small-diameter through-holes 122a and large-diameter through-holes 122b of the separator 116a, as well as through the gap 120 between the separator 116a and the inner walls of the water tank 44, and is stored in the lower space 118b. If the water in the lower space 118b is blown upwardly by the gust of exhaust gas, the blown water hits the projection 124 as indicated by the arrow X in FIG. 5, so the water does not flow back in the upper space 118a.

Water which was collected in the water tank 44 is pumped by the water pump 60 and returned to the aqueous solution tank 18 via the water return pipe 58, where it is reused as water for the methanol aqueous solution S.

If the amount of water in the water tank 44 exceeds the volume of the lower space 118b, the excess water which comes in the upper space 118a is blown upwardly by the swirling gusts of exhaust gas and discharged from the exhaust port 115 together with the exhaust gas. Thus, the amount of water in the water tank 44 is always at an appropriate level.

The water vapor liquefying operation in the gas-liquid separator 48 is achieved by operating the cooling fan 46 and thereby lowering the dew point. This operation may be controlled based on an output from the water level sensor 54 provided in the water tank 44. Such an arrangement enables a significant reduction in power consumption by the cooling fan 46.

According to the fuel cell system 10 described above, by providing the partition member 116, water in the lower space 118b becomes much less affected by the gust of exhaust gas in the upper space 118a, and thus it becomes possible to prevent the water in the water tank 44 from being blown upwardly by the swirling gusts of exhaust gas and discharged from the exhaust port 115.

Particularly in motorcycles, a large amount of exhaust gas is supplied to a small water tank. This significantly increases wind velocity in the water tank, and thus the water in the water tank can easily be blown upwardly and discharged. However, according to the fuel cell system 10, by using the partition member 116, it is possible to keep the lower space 118b undisturbed. This makes it possible to prevent unnecessary discharge of water, and to collect water easily and efficiently in a small water tank 44.

Further, there is no need for devices or for electric power to drive the devices for controlling the speed of the moisture-containing exhaust gas which blows into the water tank 44, and thus power generation efficiency does not decrease.

Further, if the amount of water in the water tank 44 exceeds the volume of the lower space 118b, water which overflows into the upper space 118a is blown upwardly by the swirling exhaust gas in the upper space 118a and discharged from the exhaust port 115, which means that the water level in the water tank 44 is controlled automatically.

In addition, by providing a plurality of small-diameter through-holes 122a and a plurality of large-diameter through-hole 122b in the separator 116a of the partition member 116, water which is introduced in the upper space 118a can fall through the small-diameter through-holes 122a and the large-diameter through-holes 122b into the lower space 118b, enabling efficient collection of water. Also, the small-diameter through-holes 122a and the large-diameter through-hole 122b increase the space of the upper space 118a or the cooling space by their volumes, facilitating liquefaction of water vapor contained in the exhaust gas thereby enabling a great amount of water to be collected.

Further, by arranging the partition member 116 so that there is a gap 120 between the inner wall of water tank 44 and the separator 116a, it becomes possible for the water which is introduced in the upper space 118a to fall through the gap 120 into the lower space 118b, enabling efficient collection of the water.

Further, even if the swirling gust of exhaust gas comes into the lower space 118b and blows the stored water, the projection 124 prevents the water from being blown upwardly. Therefore, water in the lower space 118b is not blown upwardly to be discharged from the exhaust port 115, facilitating efficient collection of water.

Further, by offsetting the inlet port 114b from the exhaust port 115 so that they will not face each other in the water tank 44, it becomes possible to let the exhaust gas which is introduced in the water tank 44 turn around before it is discharged. This prevents the moisture-containing exhaust gas, which is introduced from the inlet port 114b into the upper space 118a, from immediately being blown into the exhaust port 115 and being exhausted therefrom, thereby making it possible to collect water efficiently.

Generally in a small water tank, it is impossible to precisely detect the level of water since the swirling gust of exhaust gas which is introduced in the water tank disturbs the surface of water in the water tank. However, according to the fuel cell system 10, the partition member 116 prevents the lower space 118b from being affected by the swirling gust of exhaust gas, making it possible to store water stably in the lower space 118b and to allow the water level sensor 54 to detect the level of water accurately in the water tank 44.

Further, when introducing the moisture-containing exhaust gas from the fuel cell 12 through the intake pipe 106, the gas flows out of the trumpet-shaped inlet port 114b into the water tank 44. This reduces the velocity of moisture-containing exhaust gas as it enters the water tank 44, and thus reduces the speed of the gusts of exhaust gas which occurs in the water tank 44. Therefore, water in the water tank 44 is not spattered easily, enabling efficient collection of water. Especially in the case of a motorcycle, the fuel cell system 10 must be small and therefore the pipe 42 cannot have a large diameter, which increases the speed of the flow. However, by utilizing the intake pipe 106 having the inlet port 114b which is trumpet-shaped, the speed of the flow can be effectively reduced.

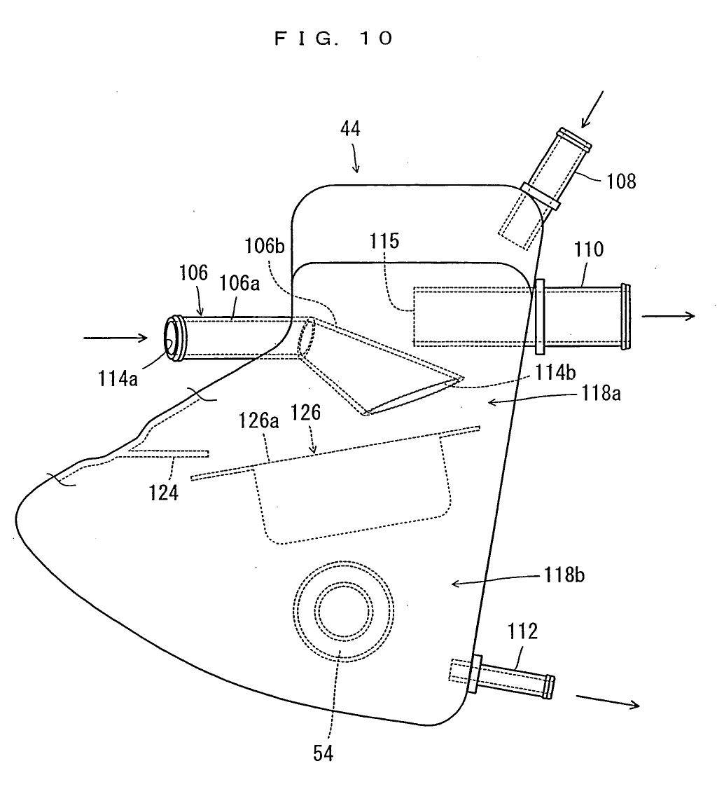

Further, as shown in FIG. 10, a partition member 126 may be fixed in the water tank 44 so that an upper surface of a separator 126a is slanted with respect to the water surface in the water tank 44. With this arrangement, water which is introduced in the upper space 118a flows on the upper surface of the separator 126a down into the lower space 118b, making water collection even more efficient.

The size and the number of through-holes to be formed in the separator may be adjusted in accordance with the rate of water contained in the exhaust gas so that the water can be collected efficiently.

It should be noted that as far as it is possible to let water flow from the upper space 118a to the lower space 118b and to prevent the water in the lower space 118b from being blown upwardly by the gust of exhaust gas, the partition member may be made of a corrugated plate, fine-mesh net, coarsely woven cloth, etc.

Further, the projection 124 may be provided below the separator 116a and spaced by a predetermined gap from the separator 116a in the water tank 44, so that the projection 124 appears to block the gap 120 entirely when viewed vertically.

An inlet port for introducing exhaust gas from the fuel cell 12 into the water tank 44 and an exhaust port for exhausting gas from the water tank 44 may be provided in the wall of the water tank 44, respectively.

The fuel cell system 10 is suitably applied not only to motorcycles but also to any transportation apparatuses such as automobiles and marine vessels.

The present invention is also applicable to fuel cell systems which make use of a methanol-water-vapor reformer, or fuel cell systems in which hydrogen is supplied to the fuel cell. Further, the present invention is applicable to small-scale, stationary-type fuel cell systems.

The present invention being thus far described and illustrated in detail, it is obvious that these description and drawings only represent examples of preferred embodiments of the present invention, and should not be interpreted as limiting the invention. The spirit and scope of the present invention is only limited by words used in the accompanied claims.

While the present invention has been described with respect to preferred embodiments thereof, it will be apparent to those skilled in the art that the disclosed invention may be modified in numerous ways and may assume many preferred embodiments other those specifically set out and described above. Accordingly, it is intended by the appended claims to cover all modifications of the present invention which fall within the true spirit and scope of the present invention.

1-10. (canceled)

11. A fuel cell system comprising:
a fuel cell which generates electric energy;
a water tank which stores water from the fuel cell;
an inlet port arranged to introduce moisture-containing exhaust gas from the fuel cell into the water tank;
an exhaust port arranged to exhaust gas from the water tank; and
a partition member which is provided in the water tank, at a position lower than the inlet port and arranged to partition an interior of the water tank into an upper space and a lower space.

12. The fuel cell system according to claim 11, wherein the partition member has a plurality of through-holes.

13. The fuel cell system according to claim 11, wherein the partition member is spaced by a gap from an inner wall of the water tank.

14. The fuel cell system according to claim 13, further comprising a projection provided in the water tank which is arranged to be spaced by a predetermined gap from the partition member and to block the gap between the inner wall of the water tank and the partition member in a vertical view.

15. The fuel cell system according to claim 11, wherein the inlet port and the exhaust port do not face each other in the water tank.

16. The fuel cell system according to claim 11, further comprising a water level sensor arranged to detect a level of water in the water tank and disposed at a position lower than the partition member in the water tank.

17. The fuel cell system according to claim 11, wherein the partition member has an upper surface that is slanted with respect to a surface of the water in the water tank.

18. A fuel cell system comprising:
a fuel cell which generates electric energy by an electro-chemical reaction;
a water tank which stores water from the fuel cell; and
an intake pipe which has a trumpet-shaped inlet port arranged to introduce moisture-containing exhaust gas from the fuel cell into the water tank and is connected with the water tank.

19. The fuel cell system according to claim 11, wherein the fuel cell system is a direct methanol fuel cell system.

20. A transportation apparatus including the fuel cell system according to claim 11.
